(19) United States
(12) Patent Application Publication
(10) Pub. No.: US 2006/0042574 A1
(43) Pub. Date: Mar. 2, 2006

(54) Combustion-type power tool providing specific spark energy

(76) Inventors: Tomomasa Nishikawa, Hitachinaka-shi (JP); Haruhisa Fujisawa, Hitachinaka-shi (JP); Shinki Ohtsu, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/209,740

(22) Filed: Aug. 24, 2005

(30) Foreign Application Priority Data
Aug. 24, 2004 (JP) P2004-243620

(51) Int. Cl. F02B 71/00; F02P 5/00

(52) U.S. Cl. 123/46 H; 123/406.57

(57) ABSTRACT

A combustion type power tool having a combustion chamber in which a fan is rotatably provided and an ignition plug is exposed. A combustible gas and air are mixed together by the fan, and the mixture is ignited by a spark generated at the ignition plug. As a result of combustion, gas expansion occurs to permit a piston and a driver blade to move for driving a fastener into a workpiece. A spark energy is set in a range of from 0.04 J to 0.08 J.

### BACKGROUND OF THE INVENTION

The present invention relates to a combustion-type power tool, and more particularly, to such power tool capable of driving a fastener such as a nail, an anchor, and a staple into a workpiece.

In a conventional combustion-type driving tool such as a nail gun, a mixture of air and gaseous fuel injected into a combustion chamber is ignited by a spark at an ignition plug to cause gas expansion in the combustion chamber, which in turn causes a linear momentum of a piston. By the movement of the piston, a nail is driven into a workpiece. Such conventional combustion-type nail gun is described in U.S. Pat. No. 5,197,646 and Japanese Patent Publication No. H03-25307.

A gas canister containing therein a combustible liquidized gas is installed in the tool. The gas canister has a gauging section for supplying a given amount of the combustible gas into the combustion chamber. However, a supply of a constant amount of the combustible gas is rather difficult due to change in ambient temperature and tool temperature. The variation of the supply amount may cause variation in gas density in the combustion chamber, which in turn leads to insufficient combustion or misfiring.

### SUMMARY OF THE INVENTION

The present inventors contemplated optimum spark energy generated by the ignition plug with respect to the gas density. A gas density distribution range capable of igniting the combustible gas can be increased if sufficient spark energy is provided, so that stabilized ignition performance can be obtained. However, power consumption of the battery is increased. On the other hand, a gas density distribution range capable of ignition can be reduced if the spark energy is insufficient, so that the stabilized ignition performance is not realized.

It is therefore an object of the present invention to provide a combustion-type power tool capable of providing a stabilized ignition performance, yet avoiding excessive power consumption of a battery, by providing an optimum spark energy of the ignition plug with respect to the gas density distribution range capable of ignition of the combustible gas.

This and other object of the present invention will be attained by a combustion-type power tool including a housing, a cylinder head, a cylinder, a piston, a combustion chamber frame, a driver blade, a fan, an ignition plug, and a spark generation unit. The housing has one end and another end. The cylinder head is disposed at the one end and formed with a fuel injection passage. The cylinder is disposed in and fixed to the housing and defines an axial direction. The piston is slidably disposed in the cylinder and reciprocally movable in the axial direction. The combustion chamber frame is disposed in the housing and movable in the axial direction. The combustion chamber frame is abuttable on the cylinder head to provide a combustion chamber in cooperation with the cylinder head and the piston. The driver blade extends in the axial direction from the piston toward the another end of the housing. The fan is rotatably disposed in the combustion chamber for agitating and mixing the air with the combustible gas. The ignition plug is exposed to the combustion chamber for igniting a mixture of air and the combustible gas injected into the combustion chamber through the fuel injection passage. The spark generation unit is configured to generate a spark energy in a range of 0.04 J to 0.08 J at the ignition plug.

### BRIEF DESCRIPTION OF THE DRAWINGS

In the drawings;

FIG. 1 is a vertical cross-sectional side view showing a combustion-type nail gun embodying a combustion-type power tool according to an embodiment of the present invention, the nail gun being in an initial phase prior to nail driving operation;

FIG. 2 is a vertical cross-sectional side view showing a nail driving phase of the combustion-type nail gun according to the embodiment;

FIG. 3 shows a spark generation circuit diagram in the embodiment; and

FIG. 4 is a graphical representation showing the relationship between a spark energy and an ignitable gas density.

### DETAILED DESCRIPTION OF THE PREFERRED EMBODIMENTS

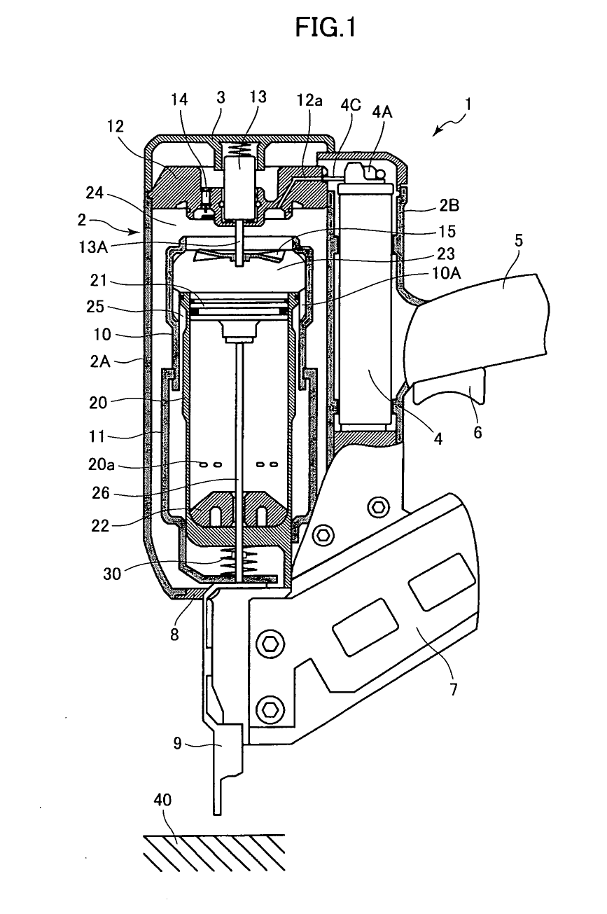

A combustion-type power tool according to one embodiment of the present invention will be described with reference to FIGS. 1 through 4. The embodiment pertains to a combustion-type nail gun. Throughout the specification, the term “upper” and “lower” are used assuming that the combustion-type nail gun is oriented in a vertical direction. The combustion-type nail gun 1 has a housing 2 constituting an outer frame and including a main housing 2A and a canister housing 2B juxtaposed thereto. The main housing 2A is formed with an exhaust port (not shown). A head cover 3 formed with an intake port (not shown) is mounted on the top of the main housing 2A. A gas canister 4 is detachably accommodated in the canister housing 2B. The gas canister 4 contains therein a combustible liquidized gas and has a gauging section 4A and an injection rod 4C extending therefrom.

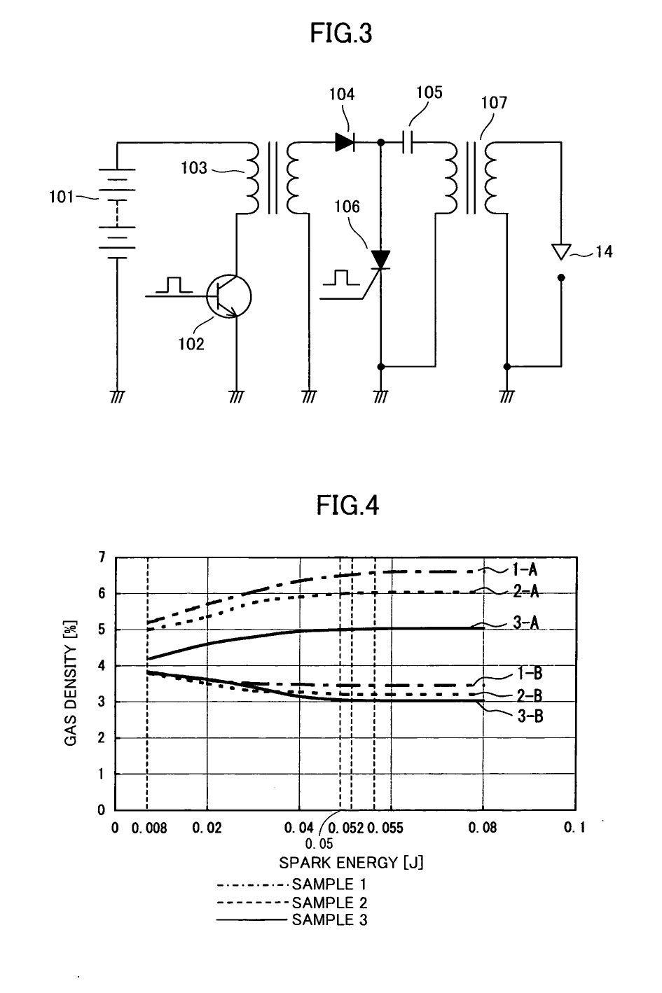

A handle 5 extends from a side of the canister housing 2B. The handle 5 has a trigger switch 6 and accommodates therein a battery 101 (FIG. 3). A magazine 7 and a tail cover 8 are disposed below the housing 2. The magazine 7 is adapted for containing therein nails (not shown), and the tail cover 8 is adapted for feeding the nail in the magazine 7 and setting the nail to a predetermined position. A push lever 9 is movably provided at a lower end of the main housing 2A. The push lever 9 has a tip end adapted to be pressed against a workpiece 40, and has an upper end portion associated with a link member 11 fixed to a combustion chamber frame 10 described later. A compression coil spring 30 is interposed between the link member 11 and a cylinder 20 (described later) for normally urging the push lever 9 in a protruding direction away from the head cover 3.

When the housing 2 is pressed toward the workpiece 40 while the push lever 9 is in abutment with the workpiece 40 against a biasing force of the compression coil spring 30, an upper portion of the push lever 9 is retractable into the main housing 2A. A cylinder head 12 is secured to the top of the main housing 2A for closing the open top end of the main housing 2A. The cylinder head 12 supports a motor 13 at a position opposite to a combustion chamber 23 described later. Further, an ignition plug 14 is also supported to the cylinder head 12 at a position adjacent to the motor 13. The ignition plug 14 has an ignition spot exposed to the combustion chamber 23. The ignition plug 14 is ignitable upon manipulation to the trigger switch 6 and upon movement of the combustion chamber frame 10 to its predetermined position because of the pressing of the push lever 9 against the workpiece 40. The motor 13 has a rotation shaft 13A, and a fan 15 positioned in the combustion chamber 23 is fixed to a tip end of the rotation shaft 13A.

A head switch (not shown) is provided in the main housing 2A for detecting an uppermost stroke end position of the combustion chamber frame 10 when the nail gun 1 is pressed against the workpiece 40. The head switch can be turned ON when the push lever 9 is elevated to a predetermined position for starting rotation of the motor 13. The cylinder head 12 has a gas canister side in which is formed a fuel injection passage 12a which allows a combustible gas to pass therethrough. One end of the fuel injection passage 12a serves as an injection port that opens at the lower surface of the cylinder head 12. Another end of the fuel injection passage 12a constitutes a gas canister connecting portion which is fluidly connected to the injection rod 4C.

The combustion chamber frame 10 is provided in the main housing 2A and is movable in the lengthwise direction thereof. The combustion chamber frame 10 is moved interlockingly in accordance with the movement of the push lever 9, since the lower end portion of the combustion chamber frame 10 is connected to the link member 11. The cylinder 20 is fixed to the main housing 2A. The combustion chamber frame 10 has an inner surface in sliding contact with the cylinder 20. Thus, the cylinder 20 guides movement of the combustion chamber frame 10. The cylinder 20 has an axially intermediate portion formed with an exhaust hole 20a. An exhaust-gas check valve (not shown) is provided to selectively close the exhaust hole 20a.

A piston 21 is slidably and reciprocally provided in the cylinder 20. The piston 21 divides an inner space of the cylinder 20 into an upper space above the piston 21 and a lower space below the piston 21. Further, a bumper 22 is provided on the bottom of the cylinder 20. The bumper 22 is made from a resilient material. When the piston 21 moves to its bottom dead center, the piston 21 is abuttable on the bumper 22.

When the upper end of the combustion chamber frame 10 abuts on the cylinder head 12, the cylinder head 12, the combustion chamber frame 10, and the upper cylinder space above the piston 21 define in combustion the combustion chamber 23.

When the upper end of the combustion chamber frame 10 is separated from the cylinder head 12, a first flow passage 24 in communication with an atmosphere is provided between the combustion chamber frame 10 and the cylinder head 12, and a second flow passage 25 in communication with the first flow passage 24 is also provided between the combustion chamber frame 10 and the upper end portion of the cylinder 20. These flow passages 24, 25 allow a combustion gas and a fresh air to pass along the outer peripheral surface of the cylinder 20 for discharging these gas through the exhaust port (not shown) of the main housing 2A. Further, the above-described intake port (not shown) of the head cover 3 is formed for supplying a fresh air into the combustion chamber 23, and the exhaust hole 20a is adapted for discharging combustion gas generated in the combustion chamber 23.

A plurality of ribs 10A protrudes radially inwardly from the portion of the combustion chamber frame 10, the portion defining the combustion chamber 23. Each rib 10A extends in the axial direction of the combustion chamber frame 10. The ribs 10A promote stirring and mixing of the air and the combustible gas in the combustion chamber 23 in cooperation with the fan 15.

Rotation of the fan 15 performs the following three functions. First, the fan 15 stirs and mixes the air with the combustible gas as long as the combustion chamber frame 10 remains in abutment with the cylinder head 12. Second, after the mixed gas has been ignited, the fan 15 causes turbulent combustion of the air-fuel mixture, thus promoting the combustion of the air-fuel mixture in the combustion chamber 23. Third, the fan 15 performs scavenging such that the exhaust gas in the combustion chamber 23 can be scavenged therefrom and also performs cooling to the combustion chamber frame 10 and the cylinder 20 when the combustion chamber frame 10 moves away from the cylinder head 12 and when the first and second flow passages 24, 25 are provided.

A driver blade 26 extends downwards from a side of the piston 21, the side being at the cylinder space below the piston 21, toward the lower end of the main housing 2A. The driver blade 26 is positioned coaxially with the nail set in the tail cover 8, so that the driver blade 26 can strike against the nail during movement of the piston 21 toward its bottom dead center. When the piston 21 moves to its bottom dead center, the tip end of the driver blade 26 strikes against the nail, and the piston 21 abuts on the bumper 22 and stops. In this case, the bumper 22 absorbs a surplus energy of the piston 21.

A spark generation circuit for generating a spark at the ignition plug 14 is shown in FIG. 3. The circuit includes the battery 101, a switching transistor 102, a boosting primary transformer 103, a diode 104, a capacitor 105, a thyristor 106, a boosting secondary transformer 107 and the ignition plug 14. The switching transistor 102 controls voltage applied to the primary transformer 103.

An energy of the spark discharge for igniting the ignition plug 14 is stored in the capacitor 105 after voltage of the battery 101 is boosted at the primary transformer 103 through the switching transistor 102. Then, the thyristor 106 is rendered ON, so that the charge accumulated in the capacitor 105 is rapidly discharged. The electric voltage is then boosted at the secondary transformer 107 so as to generate a spark at the ignition plug 14. Thus, the air-fuel mixture is ignited by the spark discharge.

The energy of the spark discharge supplied to the ignition plug 14 is set in a range of from 0.04 J to 0.08 J. The spark energy E is determined by the capacitance C of the capacitor 105 and voltage V applied to the capacitor 105 and is represented by the formula of “E=CV²/2”. Therefore, a desired spark energy can be obtained by properly selecting the capacitance C of the capacitor 105 and the voltage V applied thereto.

Next, operation of the combustion-type nail gun 1 will be described. In the non-operational state of the combustion-type nail gun 1, the push lever 9 is biased away from the cylinder head 12 as shown in FIG. 1 by the biasing force of the compression coil spring 30, so that the push lever 9 protrudes from the lower end of the tail cover 8. Thus, the uppermost end portion of the combustion chamber frame 10 is spaced away from the cylinder head 12 because the link member 11 connects the combustion chamber frame 10 to the push lever 9. Further, a part of the combustion chamber frame 10 which the part defines the combustion chamber 23 is also spaced away from the top portion of the cylinder 20. Hence, the first and second flow passages 24 and 25 are provided. In this condition, the piston 21 stays at its top dead center in the cylinder 20.

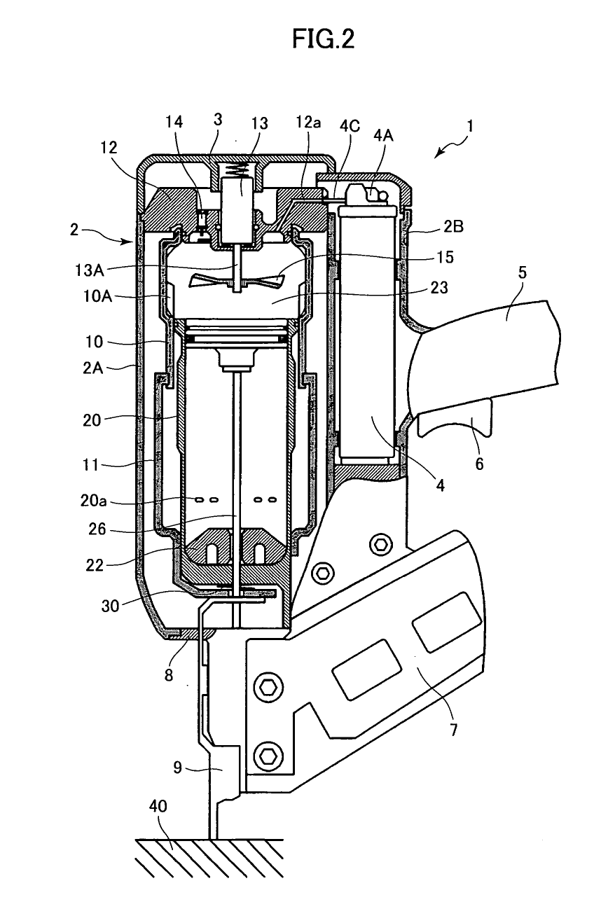

With this state, if the push lever 9 is pushed onto the workpiece 40 while holding the handle 5 by a user as shown in FIG. 2, the push lever 9 is moved toward the cylinder head 12 against the biasing force of the compression coil spring 30. At the same time, the combustion chamber frame 10 which is associated with the push lever 9 through the link member 11 is also moved toward the cylinder head 12, closing the above-described flow passages 24 and 25. Thus, the sealed combustion chamber 23 is provided.

In accordance with the movement of the push lever 9, the gas canister 4 is tiltingly moved toward the cylinder head 12 by way of a cam mechanism (not shown). Thus, the injection rod 4C of the gas canister 4 is pressed against the gas canister connecting portion of the cylinder head 12, so that the combustible liquidized gas in the gas canister 4 is injected into the combustion chamber 23 through the gauging section 4A and the fuel injection passage 12a.

Further, in accordance with the movement of the push lever 9, the combustion chamber frame 10 reaches its uppermost stroke end whereupon the head switch is turned ON to energize the motor 13 for starting rotation of the fan 15. Rotation of the fan 15 stirs and mixes the combustible gas with air in the combustion chamber 23 in cooperation with the plurality of ribs 10A.

In this state, when the trigger switch 6 provided at the handle 5 is turned ON, spark is generated at the ignition plug 14 to ignite the combustible gas. The combusted and expanded gas pushes the piston 21 to its bottom dead center. Therefore, a nail in the tail cover 8 is driven into the workpiece 40 by the driver blade 26 until the piston 21 abuts on the bumper 22.

After the nail driving, the piston 21 strikes against the bumper 22, the cylinder space above the piston 21 becomes communicated with the exhaust hole 20a. Thus, the high pressure and high temperature combustion gas is discharged out of the cylinder 20 through the exhaust hole 20a of the cylinder 20 and through the check valve (not shown) provided at the exhaust hole 20a to the atmosphere to lower the pressure in the combustion chamber 23. When the inner space of the cylinder 20 and the combustion chamber 23 becomes the atmospheric pressure, the check valve is closed. Combustion gas still remaining in the cylinder 20 and the combustion chamber 23 has a high temperature at a phase immediately after the combustion. However, the high temperature can be absorbed into the walls of the cylinder 20 and the combustion chamber frame 10. Absorption of the heat into the cylinder 20 etc. causes rapid cooling to the combustion gas. Thus, the pressure in the sealed space in the cylinder 20 above the piston 21 further drops to less than the atmospheric pressure creating a so-called “thermal vacuum”. Accordingly, the piston 21 can be moved back to the initial top dead center position.

Then, the trigger switch 6 is turned OFF, and the user lifts the combustion-type nail gun 1 from the workpiece 40 for separating the push lever 9 from the workpiece 40. As a result, the push lever 9 and the combustion chamber frame 10 move away from the cylinder head 12 because of the biasing force of the compression coil spring 30 to restore a state shown in FIG. 1. Thus, the first and second flow passages 24 and 25 are provided. In this case, the fan 15 is configured to keep rotating for a predetermined period of time after the detection of the predetermined position of the combustion chamber frame 10 by the head switch in spite of OFF state of the trigger switch 6. Thus, in the state shown in FIG. 1, fresh air is sucked into the combustion chamber 23 through the intake port formed at the head cover 3 by the rotation of the fan 15. Thus, the combustion gas is urged to flow through the first and second flow passages 24, 25, and is discharged to the atmosphere through the exhaust port formed in the main housing 2A. Thus, the combustion chamber 23 is scavenged. Then, the rotation of the fan 15 is stopped to restore an initial stationary state. Thereafter, subsequent nail driving operation can be performed by repeating the above described operation process.

Reason for setting the spark energy in a range of from 0.04 J to 0.08 J will be described. The relationship between the spark energy “J” and gas density “%” ignitable at the spark energy was investigated. The gas density implies volume of combustible gas relative to an entire inner volume of the combustion chamber. Three kinds of gases were used in the experiments. Sample 1 was propylene-methyl acetylene based gas, Sample 2 was i-butane propylene based gas, and Sample 3 was n-butane propane based gas. Test results are shown in FIG. 4 in which Samples 1, 2, 3 are represented by one dotted chain line, broken line, and solid line, respectively.

In FIG. 4, 1-A implies a maximum density of the Sample 1 ignitable at the spark energy J, and 1-B implies a minimum density of the Sample 1 ignitable at the spark energy J. The test results show that Sample 1 can be ignited if the gas density is in a range between the maximum density 1-A and the minimum density 1-B, and if the spark energy is in a range of from 0.008 J to 0.08 J.

Similar to the maximum density 1-A, 2-A and 3-A imply maximum densities of the Samples 2 and 3, respectively ignitable at the spark energy J, and similar to the minimum density 1-B, 2-B and 3-B imply minimum densities of the Samples 2 and 3, respectively ignitable at the spark energy J. The test results show that Samples 2 and 3 can be ignited if the gas density is in a range between the maximum density 2-A and the minimum density 2-B (Sample 2), and in a range between the maximum density 3-A and the minimum density 3-B (Sample 3), and if the spark energy is in a range of from 0.008 J to 0.08 J.

If the spark energy is less than 0.04 J, a range between the maximum ignitable density and the minimum ignitable density is reduced in each of the Samples. Misfiring may occur if the range between the maximum ignitable density and the minimum ignitable density is reduced, since the injection amount of the combustible gas from the gas canister 4 is instable. In view of the foregoing, the spark energy is set not less than 0.04 J so as to provide a sufficient range between the maximum ignitable density and the minimum ignitable density in order to provide a stabilized ignition performance.

Further, it is conceivable from the test result shown in FIG. 4 such that the range between the maximum ignitable density and the minimum ignitable density may not be expanded even if the spark energy is greater than 0.08 J. Moreover, battery power consumption may be accelerated with such large spark energy. Furthermore, a prolonged period is required for accumulating the spark energy of greater than 0.08 J, which is disadvantageous for the repeated nail driving operation. Consequently, the upper limit of the spark energy is set to 0.08 J.

As is apparent from FIG. 4, a distance between the maximum ignitable density and the minimum ignitable density becomes approximately constant if the spark energy is not less than 0.052 J. Therefore, the most expanded range between the maximum ignitable density and the minimum ignitable density can be obtained for each sample if the spark energy is set in the range of from 0.052 J to 0.055 J. Thus, more stabilized ignition performance can be expected if the spark energy is set in the range of from 0.05 J to 0.055 J. This range can also reduce battery power consumption.

While the invention has been described in detail and with reference to specific embodiments thereof, it would be apparent to those skilled in the art that various changes and modification may be made therein without departing from the scope of the invention. For example, the present invention is not limited to the nail gun but is available for any kind of power tools in which a combustion chamber and a piston are provided, and as long as expansion of gas as a result of combustion of air-fuel mixture in the combustion chamber causes reciprocal motion of the piston.

What is claimed is:

1. A combustion-type power tool comprising:
a housing having one end and another end;
a cylinder head disposed at the one end and formed with a fuel injection passage;
a cylinder disposed in and fixed to the housing, the cylinder defining an axial direction;
a piston slidably disposed in the cylinder and reciprocally movable in the axial direction;
a combustion chamber frame disposed in the housing and movable in the axial direction, the combustion chamber frame being abuttable on the cylinder head to provide a combustion chamber in cooperation with the cylinder head and the piston;
a driver blade extending in the axial direction from the piston toward the another end of the housing;
a fan rotatably disposed in the combustion chamber for agitating and mixing the air with the combustible gas;
an ignition plug exposed to the combustion chamber for igniting a mixture of air and the combustible gas injected into the combustion chamber through the fuel injection passage; and
a spark generation unit configured to generate a spark energy in a range of 0.04 J to 0.08 J at the ignition plug.

2. The combustion-type power tool as claimed in claim 1, wherein the spark generation unit is configured to generate the spark energy in a range of 0.05 J to 0.055 J at the ignition plug.

3. The combustion-type power tool as claimed in claim 1, wherein the combustible gas is selected from the group consisting of propylene-methyl acetylene based gas, i-butane propylene based gas, and n-butane propane based gas.

4. The combustion-type power tool as claimed in claim 1, further comprising a push lever disposed at the another end of the housing and movable in the axial direction upon pressing against a workpiece, the combustion chamber frame being associated with the push lever and being movable in interlocking relation to the movement of the push lever.

5. A combustion-type power tool comprising:
a housing defining an outer frame;
a combustion chamber disposed in the housing and selectively providing an open phase in communication with an atmosphere and a closed phase out of communication from the atmosphere;
an ignition plug exposed to the combustion chamber;
a spark generation unit configured to generate a spark energy in a range of 0.04 J to 0.08 J at the ignition plug.
